(19) United States
(12) Patent Application Publication
(10) Pub. No.: US 2025/0375871 A1
(43) Pub. Date: Dec. 11, 2025

(54) Transportable Workstation and Storage Apparatus

(71) Applicant: Queen Tattoo Company, Jacksonville Beach, FL (US)

(72) Inventors: Leticia Bomtempo, Jacksonville, FL (US); Raymond Catania, Palm Bay, FL (US); Christine Bralich, Satellite Beach, FL (US)

(21) Appl. No.: 19/235,559

(22) Filed: Jun. 11, 2025

Related U.S. Application Data
(60) Provisional application No. 63/658,466, filed on Jun. 11, 2024.

(51) Int. Cl. B25H 1/04; A47B 21/03

(52) U.S. Cl. CPC B25H 1/04; A47B 21/03; A47B 2200/0066; A47B 2200/0088

(57) ABSTRACT

The present disclosure provides generally for a transportable and sterile workstation and storage apparatus. The transportable workstation may comprise a body with a top portion and a bottom portion. The top portion may at least partially comprise a substantially flat work surface and the bottom portion may comprise one or more rolling mechanisms. The rolling mechanism(s) may be removable or alterable to a retracted position to be protected from damage. The body of the transportable workstation may comprise one or more storage receptacles configured to contain or otherwise accommodate one or more items, materials, or tools that may help a user perform or complete one or more tasks, activities, or occupational endeavors. One or more accessory components, such as lights, cameras, and screens/monitors, may be at least temporarily mounted to the transportable workstation to increase its utility.

### CROSS REFERENCE

This application claims priority to and the full benefit of U.S. Provisional Patent Application Ser. No. 63/658,466 (filed Jun. 11, 2024, and titled “TRANSPORTABLE WORKSTATION AND STORAGE APPARATUS”), the entire contents of which are incorporated in this application by reference.

### BACKGROUND

Today, working at a desk is incredibly commonplace. In fact, about 80% of the United States workforce work desk jobs. Most desks are basic planar surfaces that are configured to receive a laptop or computer while leaving room for papers, writing utensils, and perhaps some storage. If a person is lucky, they may be treated to a nicer desk that includes all the previously mentioned features but larger and with fancy materials.

A more modern development is the standing desk. These are desks that are meant to be used while standing. This twist on the desk is designed to improve posture, energy levels, and increase circulation. Standing desks are sometimes at a fixed-height, and some are adjustable, where some desks can be alterable between a standing desk and a sitting desk. While the standing desk certainly addresses and provides solutions to some of the health concerns related to sitting all day, it does not actually improve a person's work productivity or efficiency.

As hundreds of millions of individuals use desks every day, it is surprising that more innovative and creative solutions have not been developed. Despite widespread use, the fundamental design of desks has remained unchanged, failing to integrate meaningful functionality and utility beyond passive support. Desk jobs are incredibly varied and encompass a wide range of activities and tasks. Current desk configurations neglect the unique environments brought about in different professions that provide opportunities for desks that go above and beyond.

Therefore, there is a deficiency in the availability of desks that do not simply provide a space from which to work but that enhance productivity, improve organization, and integrate features that assist in task completion. An adaptable, transportable, and sterile environment that may be adjusted to a specific desk job's need may address the shortcomings of conventional desks. This development may bring forward a multifunctional platform to improve the daily life of the modern worker.

### SUMMARY OF THE DISCLOSURE

What is needed is a transportable workstation that provides a sterile environment that is moveable and contains storage for a variety of different work projects. In some embodiments, the transportable workstation may include a body with one or more sidewalls, wherein the one or more sidewalls may be planarly shaped such that the body may include a cuboidal configuration.

In some embodiments, the transportable workstation may include at least one work surface that may include a flat surface configured as a top surface of the transportable workstation. In some implementations, one or more slots may be configured on the body of the transportable workstation, wherein the at least one workstation may include one or more protruding members that may extend downwardly from a bottom portion of the at least one work surface configured to be slidably received by the one or more slots.

In some implementations, a handle may be configured to extend upwardly and inwardly from the body. In some aspects, one or more tracks may be configured on the body of the transportable workstation, wherein the handle may be configured to be slidably received by the one or more tracks to allow vertical movement within a longitudinal plane of the transportable workstation. In some embodiments one or more rolling mechanisms may be at least temporarily fixed to the bottom portion of the body to facilitate traversal of the transportable workstation in at least one linear direction upon a surface.

A number of embodiments of the present disclosure will be described. While this specification contains many specific implementation details, these should not be construed as limitations on the scope of any disclosures or of what may be claimed, but rather as descriptions of features specific to particular embodiments of the present disclosure. It is understood to those skilled in the art that variations, modifications, and alterations may be apparent. It will be understood that various modifications may be made without departing from the spirit and scope of the disclosure.

### BRIEF DESCRIPTION OF THE DRAWINGS

The accompanying drawings that are incorporated in and constitute a part of this specification illustrate several embodiments of the disclosure and, together with the description, serve to explain the principles of the disclosure:

FIG. 1 illustrates an exemplary transportable workstation, according to some embodiments of the present disclosure.

FIG. 2 illustrates an exemplary transportable workstation, according to some embodiments of the present disclosure.

FIG. 3A illustrates exemplary rolling mechanisms for a transportable workstation, according to some embodiments of the present disclosure.

FIG. 3B illustrates exemplary rolling mechanisms for a transportable workstation, according to some embodiments of the present disclosure.

FIG. 4 illustrates an exemplary transportable workstation, according to some embodiments of the present disclosure.

FIG. 5 illustrates an exemplary transportable workstation, according to some embodiments of the present disclosure.

FIG. 6 illustrates an exemplary transportable workstation, according to some embodiments of the present disclosure.

FIG. 7 illustrates an exemplary transportable workstation, according to some embodiments of the present disclosure.

The Figures are not necessarily drawn to scale, as their dimensions can be varied considerably without departing from the scope of the present disclosure.

### DETAILED DESCRIPTION

The present disclosure provides generally for transportable workstations and storage apparatus. According to the present disclosure, a transportable workstation may comprise one or more storage receptacles, at least one work surface, and one or more rolling mechanisms. In some aspects, the transportable workstation may comprise at least one handle, such that a user may be able to push or pull the transportable workstation via the rolling mechanisms using the handle. In some implementations, the work surface of the transportable workstation may be configured to be moved or adjusted in at least one direction to accommodate users of different heights or occupations, as non-limiting examples. In some embodiments, the transportable workstation may be configured to facilitate one or more tasks, occupations, or activities, such as, for example and not limitation, tattoo artistry.

In the following sections, detailed descriptions of examples and methods of the disclosure will be given. The descriptions of both preferred and alternative examples, though thorough, are exemplary only, and it is understood to those skilled in the art that variations, modifications, and alterations may be apparent. It is therefore to be understood that the examples do not limit the broadness of the aspects of the underlying disclosure as defined by the claims.

### Glossary

Workstation: as used herein refers to any device, mechanism, or apparatus that may at least partially facilitate performance, execution, or completion of at least one task, activity, occupation, or hobby, such as, for example and not limitation, tattoo artistry.

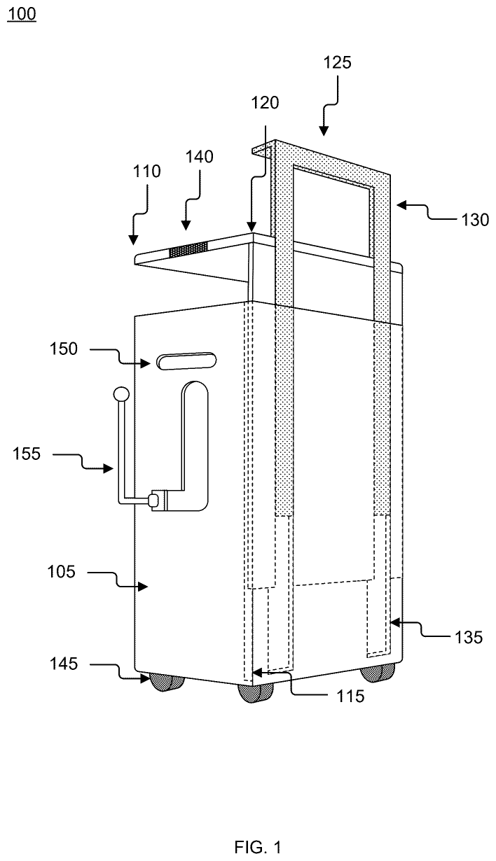

Referring now to FIG. 1, an exemplary transportable workstation 100, according to some embodiments of the present disclosure, is illustrated. In some aspects, the transportable workstation 100 may comprise a body 105. In some non-limiting exemplary embodiments, the body 105 may comprise one or more sidewalls configured around a generally hollow or open center portion, such as to form a shell-like structure or casing. In some implementations, each of the sidewalls of the body 105 may be substantially planar such that the body 105 may comprise a cuboidal configuration.

In some embodiments, the transportable workstation 100 may comprise at least one work surface 110. By way of example and not limitation, the work surface 110 may comprise a substantially flat surface upon which one or more tools, materials, resources, or other items may be at least temporarily configured to be accessed by a user while engaging in one or more tasks, activities, or occupations. In some aspects, the work surface 110 may include small ridges on its edges, wherein the small ridges may prevent objects and tools from rolling off of the work surface 110. In some non-limiting exemplary implementations, the work surface 110 may be configured at or proximate to an upper portion of the transportable workstation 100. In some embodiments, the work surface 110 may comprise the top surface of the transportable workstation 100. The work surface 110 may be fixed/hung on the backside of the handle.

In some aspects, the work surface 110 may be configured to be adjustable. By way of example and not limitation, the work surface 110 may be configured to be movable in at least one direction. In some implementations, the work surface 110 may be configured to move up and down along a longitudinal axis of the transportable workstation 100. In some aspects, this vertical longitudinal movement may allow a user to move the work surface 110 to a height that may be best suited for a task, activity, or occupation while accommodating the user's size and/or working position. In some embodiments, the work surface 110 may comprise one or more substantially rigid or durable materials, such as stainless steel and other metals, as non-limiting examples. In some implementations, the work surface 110 may be medical grade, wherein the work surface 110 may be sterilized.

In some implementations, longitudinal movement of the work surface 110 may be facilitated by one or more grooves, channels, or slots 115. In some embodiments, the slot(s) 115 may be configured at or proximate to an outer edge or perimeter of the body 105. In some non-limiting exemplary implementations, the slot(s) 115 may be configured upon an outer surface of the body 105, or the slot(s) may be configured internally within the body 105 or within an inner portion of one or more of the sidewalls of the body 105, as non-limiting examples.

In some aspects, at least one protruding member 120 may extend downwardly from a bottom portion of the work surface 110, wherein the protruding member(s) 120 may be configured to be slidably received by the slot(s) 115. In some implementations, the work surface 110 may comprise a single protruding member 120 with a tabular or planar configuration, or the work surface 110 may comprise a plurality of protruding members 120 configured as posts or pillars, as non-limiting examples.

In some embodiments, the transportable workstation 100 may comprise at least one handle 125. In some implementations, the handle 125 may be configured to extend upwardly from the body 105 when in use, and to retract towards and, in some aspects, into the body 105 when not in use, wherein upon full retraction a top portion of the handle 125 may be substantially flush with a top surface of the transportable workstation 100. In some aspects, the top surface or top portion of the transportable workstation 100 may comprise an indentation, groove, or similar recess for temporarily receiving the handle 125 when in the retracted position.

In some implementations, the handle 125 may comprise one or more posts, pillars, or similar elongated members 130 that may be slidably received by one or more channels or tracks 135, thereby allowing the handle 125 to move vertically within a longitudinal plane of the transportable workstation 100. In some non-limiting exemplary embodiments, the track(s) 135 may be configured upon one or more external portions of the body 105, or the track(s) 135 may be configured internally within the body 105 or within an internal portion of one or more of the sidewalls of the body 105, as non-limiting examples. In some implementations, by way of example and not limitation, the track(s) 135 may be configured at or proximate to one or more corners of the body 105.

In some aspects, the work surface 110 and/or the handle 125 may be configured to be locked at one or more heights above the top portion of the transportable workstation 100, wherein locking the work surface 110 and/or the handle 125 may at least temporarily minimize or prevent unintentional movement of the work surface 110 and/or the handle 125 in the vertical direction or in any direction. There may exist the possibility of having the work surface extending horizontally. In some implementations, one or more pins, detents, or similar catching or locking mechanisms integrated with the protruding member 120 and/or the elongated member(s) 130 may be configured to be removably secured within one or more holes, apertures, or recesses within the slot(s) 115 and/or the track(s) 135 to at least temporarily secure the work surface 110 and/or the handle 125 at one or more heights above the top portion of the transportable workstation 100.

In some embodiments, the work surface 110 and/or the handle 125 may comprise at least one release mechanism 140. In some aspects, by way of example and not limitation, the release mechanism 140 may comprise a button, switch, lever, or similar actuator that may be configured to be engaged by a user to unlock the work surface 110 and/or handle 125 from a first vertical position such that the work surface 110 and/or handle 125 may be moved to a second vertical position. In some non-limiting exemplary implementations, engaging the release mechanism 140 may cause one or more catching or locking mechanisms associated with the protruding member 120 and/or the elongated member(s) 130 to be released from one or more recesses within the corresponding slot(s) 115 and/or the track(s) 135.

In some aspects, the transportable workstation 100 may comprise one or more rolling mechanisms 145. In some implementations, the rolling mechanism(s) 145 may be at least temporarily affixed or secured to a bottom portion or bottom surface of the body 105 of the transportable workstation 100. In some embodiments, by way of example and not limitation, the rolling mechanism(s) 145 may comprise casters, rollers, wheels, or similar devices. In some implementations, the rolling mechanism(s) 145 may facilitate traversal of the transportable workstation 100 in at least one linear direction upon a surface, such as, for example and not limitation, by using the handle 125 to push or pull the transportable workstation 100. In some aspects, at least one of the rolling mechanisms 145 may comprise at least one locking mechanism that may be configured to at least temporarily immobilize the rolling mechanism 145 such that unintentional movement of the transportable workstation 100 may be minimized or prevented. By way of example and not limitation, at least one of the rolling mechanisms 145 may comprise at least one locking mechanism in the form of a clamp that may be configured to securely grip the associated rolling mechanism 145 when in a locked position to minimize or prevent unintentional rotation of the rolling mechanism 145. In some implementations, the locking mechanism may be altered between the locked and unlocked positions by at least one physical actuator, such as, for example and not limitation, a lever, switch, or button, or at least one electronic actuator, such as, for example and not limitation, an electric motor, wherein the physical actuator may be manually manipulated by a user and the electronic actuator may be manipulated by a user via an electrical button, switch, or device.

In some embodiments, the body 105 of the transportable workstation 100 may comprise one or more secondary handles 150. In some aspects, by way of example and not limitation, the secondary handle(s) 150 may be affixed to or integrated with an outer external surface of one or more sidewalls of the body 105. In some non-limiting exemplary implementations, the secondary handle(s) 150 may comprise indentations or recesses within one or more sidewalls of the body 105, such that the secondary handle(s) 150 may be flush with the outer external surface of the sidewall(s), or the secondary handle(s) 150 may comprise metallic, plastic, or similar structures that may be affixed to or that may protrude from one or more sidewalls of the body 105. In some aspects, the secondary handle(s) 150 may facilitate movement of the transportable workstation 100 without using the rolling mechanism(s) 145, such as by lifting the transportable workstation 100 when the handle 125 may be in the retracted position, as a non-limiting example.

In some implementations, the transportable workstation 100 may comprise one or more ancillary components 155. In some aspects, the ancillary component(s) 155 may be affixed to or integrated with an outer external surface of one or more sidewalls of the body 105. In some embodiments, the ancillary component(s) 155 may be configured to be movable between an extended position and a retracted position, wherein the extended position may comprise an in-use position that places the ancillary component(s) 155 at an exposed or otherwise accessible location and the retracted position comprises an embedded configuration within one or more indentations or recesses within the sidewall(s) of the body. In implementations, by way of example and not limitation, the ancillary component(s) 155 may be altered between the extended position and the retracted position by rotating or pivoting about at least one hinge or via translational movement achieved using at least one telescoping mechanism, as non-limiting examples. As a non-limiting illustrative example, an ancillary component 155 may comprise a paper towel holder.

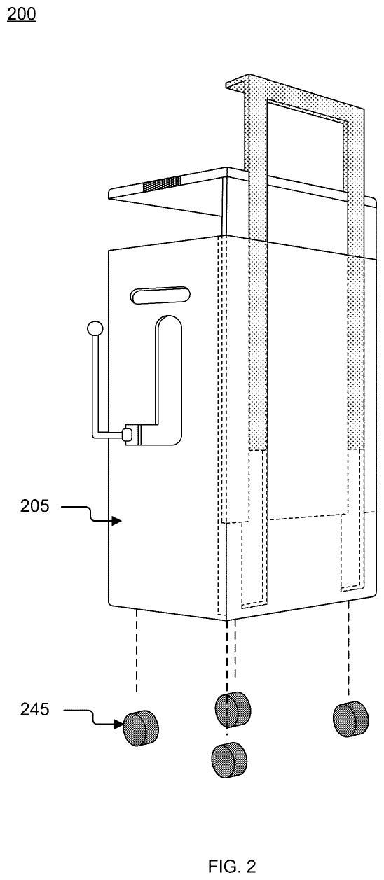

Referring now to FIG. 2, an exemplary transportable workstation 200, according to some embodiments of the present disclosure, is illustrated. In some aspects, the transportable workstation 200 may comprise one or more rolling mechanisms 245 that may be at least temporarily detachable and removable. In some implementations, removal of the rolling mechanism(s) 245 may prevent damage to the rolling mechanism(s) 245 in situations wherein the transportable workstation 200 may be prone to impact or shock forces, such as when the transportable workstation 200 may be stowed within a mass transit carrier like an airplane, bus, or cruise ship, as non-limiting examples.

In some embodiments, the rolling mechanism(s) 245 may comprise one or more snap-fit mechanisms that may allow the rolling mechanism(s) 245 to be removed from and secured to a bottom portion of the body 205 of the transportable workstation 200 by applying a threshold amount of force. In some implementations, the rolling mechanism(s) 245 may comprise one or more assemblies that may be secured to and removed from the transportable workstation 200 using one or more fasteners, such as screws, pins, nails, clamps, or bolts, as non-limiting examples.

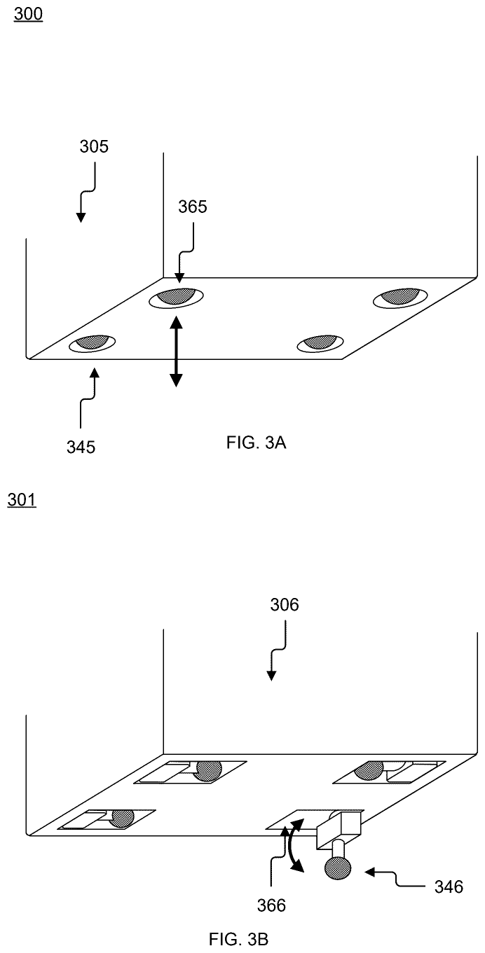

Referring now to FIGS. 3A-3B, exemplary rolling mechanisms 345, 346 for a transportable workstation 300, 301 according to some embodiments of the present disclosure, are illustrated. In some aspects, a bottom portion of the body 305, 306 of the transportable workstation 300, 301 may comprise one or more indentations or recesses 365, 366 that may be configured to at least temporarily receive the rolling mechanism(s) 345, 346 in a retracted position such that the rolling mechanism(s) 345, 346 may not extend beyond the bottom surface of the body 305, 306 when retracted. In some implementations, this may allow the rolling mechanism(s) 345, 346 to be protected from potential damage from impact forces when not in use.

In some non-limiting exemplary embodiments, the rolling mechanism(s) 345 may be configured to extend from and retract into the recess(es) 365 in a telescoping fashion. In some implementations, each rolling mechanism 345 may comprise an assembly or housing that may be twisted, pulled, and/or pushed to move each rolling mechanism 345 between the extended position and the retracted position. In some embodiments, the assembly or housing of each rolling mechanism 345 may be configured to interact with at least one spring mechanism, such as, for example and not limitation, a compression spring, wherein the spring mechanism may push the associated rolling mechanism 345 to the extended position when one or more detents, pins, catches, or similar temporary securing mechanisms are released by at least one physical or electronic actuator.

In some aspects, each rolling mechanism 346 may comprise an assembly or housing that may be configured to rotate or pivot about at least one hinge to alter the associated rolling mechanism 346 between the extended position and the retracted position. In some implementations, the assembly or housing of each rolling mechanism 346 may be configured to interact with at least one spring mechanism, such as, for example and not limitation, a compression spring or an extension spring, that may be configured to push the associated rolling mechanism 346 to the extended position and/or pull the rolling mechanism 346 to the retracted position when one or more detents, pins, catches, or similar temporary securing mechanisms are released by at least one actuator.

In some non-limiting exemplary embodiments, one or more of the rolling mechanism(s) 345, 346 of the transportable workstation 300, 301 may comprise a housing or assembly that may be configured to be automatically altered between the extended position and the retracted position based at least partially on the orientation of the transportable workstation 300, 301. In some implementations, the rolling mechanism(s) 345, 346 may be configured to automatically move to the extended position when the transportable workstation 300, 301 is in a substantially vertical upright position with the top surface of the body 305, 306 facing upward. In some aspects, the rolling mechanism(s) 345, 346 may be configured to be automatically extended when the transportable workstation 300, 301 is within a predetermined threshold deviation from the substantially vertical position. By way of example and not limitation, the rolling mechanism(s) 345, 346 may be configured to be extended when the transportable workstation 300, 301 is offset from the vertical upright position by a tilt angle of 10 degrees or less.

In some implementations, the transportable workstation 300, 301 may comprise at least one controller communicatively coupled to at least one sensing device and at least one actuating mechanism. In some aspects, the sensing device may be configured to facilitate one or more detections, such that the detection(s) may be transmitted to the controller thereby allowing the controller to determine an orientation of the transportable workstation 300, 301 and instruct the actuating mechanism to engage or refrain from engaging based at least partially on the determined orientation. As a non-limiting illustrative example, the sensing device may comprise an accelerometer and the actuating mechanism may comprise an electric motor configured to displace a pin or detent to release the housing or assembly of a rolling mechanism 345, 346 to allow a compression spring to push the rolling mechanism 345, 346 to the extended position when the accelerometer detects data that enables the controller to determine that the transportable workstation 300, 301 is in the substantially vertical upright position.

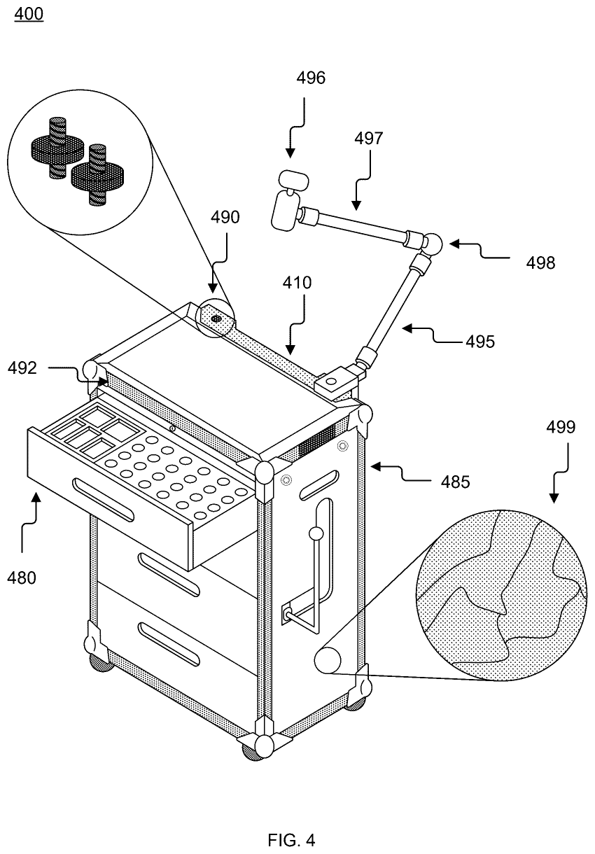

Referring now to FIG. 4, an exemplary transportable workstation 400, according to some embodiments of the present disclosure, is illustrated. In some aspects, the transportable workstation 400 may comprise one or more storage receptacles 480. In some non-limiting exemplary implementations, the storage receptacles 480 may be configured as shelves or drawers. In some embodiments, the transportable workstation 400 may comprise a plurality of storage receptacles 480, wherein the storage receptacles 480 may comprise the same or different shapes, sizes, and/or dimensions. As a non-limiting illustrative example, the transportable workstation 400 may comprise three to five storage receptacles 480 in the form of drawers, wherein the top drawer may comprise a vertical height that is less than the height of each of the bottom drawers. In some implementations, the transportable workstation 400 may comprise one or more doors configured to cover one or more portions of the transportable workstation 400 when in the closed position, such as, for example and not limitation, one or more shelves and/or drawers.

In some embodiments, one or more of the storage receptacles 480 may comprise one or more built-in structures or compartments to maximize utility of the storage receptacle(s) 480 for an intended use, purpose, activity, task, or occupation. By way of example and not limitation, the transportable workstation 400 may comprise at least one storage receptacle 480 that comprises one or more built-in compartments configured to contain one or more inks or tools pertaining to tattoo artistry, as a non-limiting example. In some aspects, the built-in nature of the compartments may prevent displacement and/or tipping of the compartments and the resulting spillage of the inks, thereby limiting or preventing waste and mess.

In some embodiments, the transportable workstation 400 may comprise at least one locking mechanism 492, such as, for example and not limitation, a key lock, a combination lock, or an electronic lock, as non-limiting examples. In some aspects, the locking mechanism 492 may be configured to simultaneously alter all of the storage receptacles 480 between a locked state and an unlocked state. As a non-limiting illustrative example, the storage receptacles 480 may comprise drawers, and the locking mechanism 492 may be configured to prevent the drawers from opening when in the locked state wherein one or more physical elements block the drawers from opening, while the drawers may open freely when the locking mechanism 492 is in the unlocked state.

In some implementations, the transportable workstation 400 may comprise an outer frame 485. In some aspects, the frame 485 may comprise one or more portions configured at one or more of the edges and/or corners of the body 405. In some embodiments, the frame 485 may comprise one or more substantially rigid and durable materials configured to withstand and absorb one or more shock or impact forces to reduce, prevent, or minimize damage to the transportable workstation 400, such as one or more metals, hard plastics, or rubber, as non-limiting examples. In some implementations, the frame 485 may extend beyond the exterior surface of the body 405 to physically block large objects, structures, or surfaces from contacting the body 405. By way of example and not limitation, the frame 485 may extend from 0.125 inches to 0.75 inches, or 0.25 inches beyond the exterior surface of the body 405.

In some aspects, the transportable workstation 400 may comprise one or more accessory mounts 490. In some implementations, the accessory mount(s) 490 may enable one or more tools, instruments, utility devices, or similar accessory components to be temporarily or removably secured to the transportable workstation 400. In some non-limiting exemplary embodiments, the accessory mount(s) 490 may be configured at or proximate to the top portion or top surface of the transportable workstation 400 and/or the top portion of the handle 410.

In some implementations, the accessory mount(s) 490 may comprise female threaded structures configured to receive corresponding male threaded screws, wherein the screws may pass through an opening in an accessory component to temporarily and removably secure the accessory component to the transportable workstation 400. By way of example and not limitation, the threaded structures and threaded screws may comprise a diameter of approximately 0.125 inches to one inch, or approximately 0.25 inches, as non-limiting examples. In some implementations, the accessory components may include cold shoes or ball head mounts, as non-limiting examples, wherein the accessory components may be attached to the transportable workstation 400 through the accessory mount(s) 490.

In some embodiments, at least one extension arm 495 may be used to at least temporarily secure one or more accessory components, such as, for example and not limitation, a lighting mechanism 496, to the transportable workstation 400. In some aspects, the extension arm 495 may be configured with one or more telescoping portions 497, hinges 498, and/or similar movement-facilitating mechanisms to enable a user to position the associated accessory component at a preferred or required position or orientation.

In some non-limiting exemplary implementations, one or more portions of the external outer surface of the body 405 may comprise a textured or variable surface structure to increase the durability of the surface. By way of example and not limitation, the body 405 may comprise a rock-like surface 499, such as, for example and not limitation, Durafoam™ closed cell sponge rubber and plastic foam available from Monmouth Rubber and Plastics Corporation of Long Branch, NJ, for increased protection from impact forces.

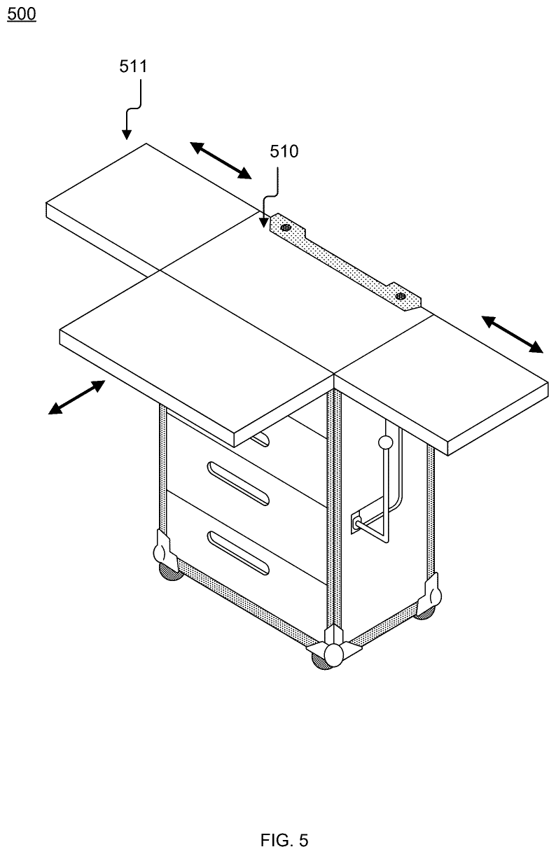

Referring now to FIG. 5, an exemplary transportable workstation 500, according to some embodiments of the present disclosure, is illustrated. In some aspects, the top portion of the transportable workstation 500 may comprise a work surface 510 with one or more extendable portions 511. In some implementations, each of the extendable portion(s) 511 may be configured to be altered between an extended position and a retracted position, such that the extendable portion(s) 511 may be hidden or concealed when in the retracted position so as to not contribute to the structural profile of the transportable workstation 500.

In some non-limiting exemplary embodiments, the extendable portion(s) 511 of the work surface 510 may be configured to slide between the retracted position and the extended position. By way of example and not limitation, an internal portion of the transportable workstation 500 may comprise one or more grooves, indentations, or tracks that may slidably receive at least a portion of each extendable portion 511 such that each extendable portion 511 may be able to completely slide, fold, or retract from the internal portion of the transportable workstation 500 to achieve the retracted position and out of the internal portion of the transportable workstation 500 to achieve an at least partially extended position. In some implementations, opposing front and rear sides or edges of the extendable portion(s) 511 may be configured to slidably engage with the tracks. In some aspects, the opposing sides or edges may comprise one or more wheels, rollers, or similar rolling mechanisms to facilitate sliding of the extendable portion(s) 511 within or upon the tracks. In some embodiments, the transportable workstation 500 may comprise a plurality of extendable portions 511 that may be configured to slidably receive one another in a telescoping configuration, such that a first extendable portion 511 may be configured to completely retract into and extend outwardly from an internal portion of a second extendable portion 511, with this configuration being repeatable any desired number of times.

In some non-limiting exemplary implementations, the extendable portion(s) 511 of the work surface 510 may be configured achieve the retracted position by folding or collapsing into an internal portion of the transportable workstation 500. In some aspects, each extendable portion 511 may comprise one or more hinges to allow the extendable portion(s) 511 to be moved between a collapsed retracted position within the transportable workstation 500 and an extended position wherein laterally adjacent extendable portions 511 form a continuous flat surface that is substantially coplanar with the work surface 510. In some embodiments, the extendable portion(s) 511 may be temporarily locked or secured in the extended or retracted position using one or more securing mechanisms, such as clamps, detents, and/or latches, as non-limiting examples.

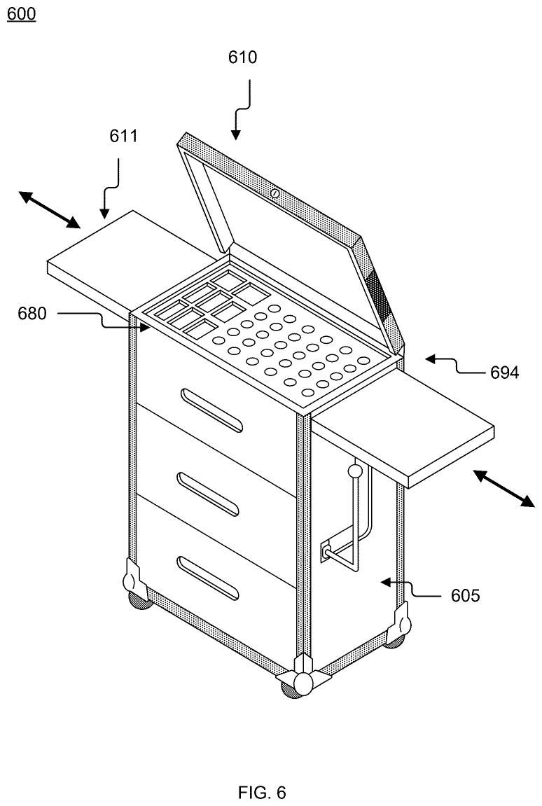

Referring now to FIG. 6, an exemplary transportable workstation 600, according to some embodiments of the present disclosure, is illustrated. In some aspects, at least one portion of the top portion 610 of the transportable workstation 600 may be configured to pivot about one or more hinges 694. In some implementations, by way of example and not limitation, a rear side or edge of the top portion 610 of the transportable workstation 600 may comprise one or more hinges 694 to enable the top portion 610 to pivot between a closed position wherein the front side or edge of the top portion 610 physically contacts the top of the front sidewall of the body 605 of the transportable workstation 600 and an at least partially open position wherein an interior portion of an upper storage receptacle 680 of the transportable workstation 600 may be exposed or otherwise accessible.

In some non-limiting exemplary embodiments, the upper storage receptacle 680 of the transportable workstation 600 may comprise one or more built-in structures or compartments to maximize utility of the storage receptacle 680 for an intended use, purpose, activity, task, or occupation. By way of example and not limitation, the upper storage receptacle 680 may comprise one or more built-in compartments configured to contain one or more inks or tools pertaining to tattoo artistry, as non-limiting examples. In some aspects, the built-in nature of the compartments may prevent displacement and/or tipping of the compartments and the resulting spillage of the inks, thereby preventing or limiting waste and mess.

In some aspects, the top portion 610 of the transportable workstation 600 may comprise one or more locking or securing mechanisms to maintain the top portion 610 in the open position and prevent unintentional closing of the top portion 610. In some implementations, by way of example and not limitation, one or more of the hinges 694 may comprise one or more detents, prongs, tabs, or similar securing mechanisms that may be moved to a locked position to physically block movement of the hinge(s) 694 until a user physically engages a release mechanism or actuator to unlock the hinge(s) 694 and enable free unrestricted movement of the hinge(s) 694. In some embodiments, each of the securing mechanism(s) may be configured to interact with one or more spring mechanisms that may be configured to automatically move the securing mechanism(s) to the locked position when the top portion 610 achieves the fully open position. In some implementations, the securing mechanism(s) may be configured to be altered to the locked and/or unlocked position by being manually manipulated by a user.

In some embodiments, the pivoting nature of the top portion 610 of the transportable workstation 600 may hinder utilization of the top portion 610 as a work surface. In some implementations, the transportable workstation 600 may comprise one or more extendable portions 611 that may be configured to be altered between a retracted position and an extended position, such that the extendable portion(s) 611 may be used as work surface(s) when in the extended position. By way of example and not limitation, an internal portion of the transportable workstation 600 may comprise one or more grooves, indentations, or tracks that may slidably receive at least a portion of each extendable portion 611 such that each extendable portion 611 may be able to completely slide into the internal portion of the transportable workstation 600 to achieve the retracted position and out of the internal portion of the transportable workstation 600 to achieve an at least partially extended position.

In some implementations, opposing front and rear sides or edges of the extendable portion(s) 611 may be configured to slidably engage with the tracks. In some aspects, the opposing sides or edges may comprise one or more wheels, rollers, or similar rolling mechanisms to facilitate sliding of the extendable portion(s) 611 within or upon the tracks. In some embodiments, the transportable workstation 600 may comprise a plurality of extendable portions 611 that may be configured to slidably receive one another in a telescoping configuration, such that a first extendable portion 611 may be configured to completely retract into and extend outwardly from an internal portion of a second extendable portion 611, with this configuration being repeatable any desired number of times.

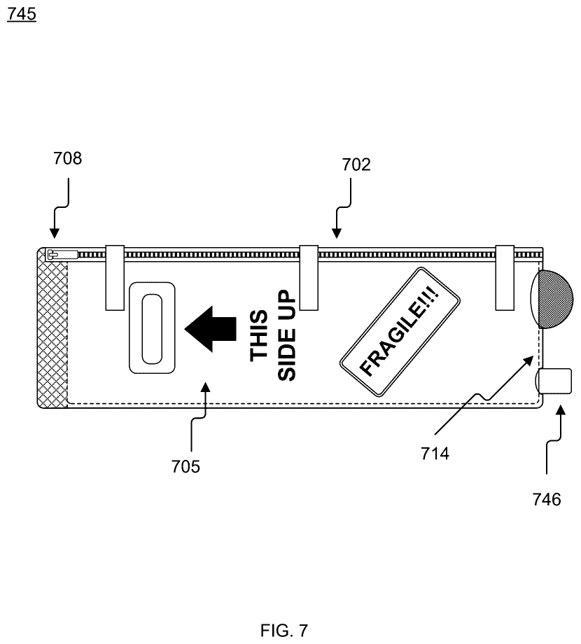

Referring now to FIG. 7, an exemplary transportable workstation 700, according to some embodiments of the present disclosure, is illustrated. In some aspects, the transportable workstation 700 may be configured to be at least partially enclosed within an enclosing mechanism 702, such as a wrap or case, as non-limiting examples. In some implementations, the enclosing mechanism 702 may be configured to secure and protect the transportable workstation 700 during transport. By way of example and not limitation, the enclosing mechanism 702 may be configured to provide a physical barrier that minimizes or prevents unintentional movement of any drawers, doors, work surfaces, extendable portions, or similar moving components of the transportable workstation 700.

In some non-limiting exemplary embodiments, the enclosing mechanism 702 may comprise one or more flexible materials configured to fit around the body 705 of the transportable workstation 700 when all of the drawers, doors, extendable portions, or other moving components are in the fully retracted or closed position, if relevant. In some implementations, the enclosing mechanism 702 may comprise one or more at least partially elastic materials to enable the enclosing mechanism 702 to fit tightly against the body 705, which may help minimize or prevent unwanted or unintentional movement of any of the moving components of the transportable workstation 700. In some aspects, the enclosing mechanism 702 may at least partially comprise one or more padded or shock-absorbing materials to protect the transportable workstation 700 from potentially damaging impact forces, such as, for example and not limitation, lightweight foam, rubber, canvas, fabric, or plastic.

In some implementations, the enclosing mechanism 702 may comprise at least one fastening element 708 configured to secure the enclosing mechanism to or around the transportable workstation 700. By way of example and not limitation, the fastening element 708 may comprise one or more of: a zipper, a hook-and-loop fastener, a strap, a magnet, a buckle, and a snapping mechanism, as non-limiting examples.

In some aspects, the bottom portion 714 of the transportable workstation 700 may comprise one or more devices or structures other than rolling mechanisms 745. By way of example and not limitation, the bottom portion 714 may comprise one or more solid, stationary nonmoving elements, such as, for example and not limitation, one or more pegs 746. In some implementations, such non moving components may provide stability and minimize unintentional movement of the transportable workstation 700 when in the vertical upright resting position.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described components and systems can generally be integrated together in a single product or packaged into multiple products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

Reference in this specification to “one embodiment,” “an embodiment,” any other phrase mentioning the word “embodiment”, “aspect”, or “implementation” means that a particular feature, structure, or characteristic described in connection with the embodiment is included in at least one embodiment of the disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional.

Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward,” “inboard,” “outboard” and “below” used herein are merely for ease of description and refer to the orientation of the components as shown in the figures. It should be understood that any orientation of the components described herein is within the scope of the present invention.

What is claimed is:

1. A transportable workstation including:
a body with one or more sidewalls, wherein the one or more sidewalls are planar such that the body comprises a cuboidal configuration;
at least one work surface that is a flat surface configured as a top surface of the transportable workstation;
one or more slots configured on the body of the transportable workstation, wherein the at least one workstation includes one or more protruding members that extend downwardly from a bottom portion of the at least one work surface configured to be slidably received by the one or more slots;
a handle configured to extend upwardly and inwardly from the body;
a plurality of accessory mounts configured to receive one or more accessories into each of the plurality of accessory mounts, wherein at least one of the plurality of accessory mounts is located on the handle;
one or more tracks configured on the body of the transportable workstation, wherein the handle is configured to be slidably received by the one or more tracks to allow vertical movement within a longitudinal plane of the transportable workstation, wherein the at least one work surface and the handle is configured to be locked at one or more heights above a top portion of the transportable workstation, wherein locking the at least one work surface or handle at least temporarily prevents unintentional movement of the at least one work surface or handle; and
one or more rolling mechanisms at least temporarily fixed to a bottom portion of the body to facilitate traversal of the transportable workstation in at least one linear direction upon a surface.

2. The transportable workstation of claim 1, wherein the one or more sidewalls create a generally hollow body to form a shell-like structure.

3. The transportable workstation of claim 1, wherein the at least one work surface includes small ridges on its edges to prevent objects and tools from rolling off the at least one work surface.

4. The transportable workstation of claim 1, wherein the one or more slots are configured upon an outer surface of the body.

5. The transportable workstation of claim 1, wherein the one or more slots are configured within an inner portion of the one or more sidewalls of the body.

6. The transportable workstation of claim 1, further including one or more extendable portions extending from the at least one work surface configured to be altered between a retracted position and an extended position.

7. The transportable workstation of claim 1, wherein the transportable workstation is configured to be at least partially enclosed within an enclosing mechanism, where the enclosing mechanism includes one or more at least partially elastic materials to enable the enclosing mechanism to fit tightly against the body, which may help minimize or prevent unwanted or unintentional movement of any of the moving components of the transportable workstation.

8. The transportable workstation of claim 1, wherein the at least one work surface or handle includes at least one release mechanism configured to unlock the at least one work surface or handle a locked position.

9. The transportable workstation of claim 1, wherein the rolling mechanisms includes wheels.

10. The transportable workstation of claim 1, wherein the rolling mechanisms include at least one locking mechanism configured to at least temporarily immobilize the rolling mechanism to prevent unintentional movement of the transportable workstation.

11. The transportable workstation of claim 10, wherein the at least one locking mechanism is a clamp configured to securely grip an associated rolling mechanism to prevent rotation.

12. The transportable workstation of claim 10, wherein the at least one locking mechanisms is alterable between a locked and unlocked position by at least one physical actuator.

13. The transportable workstation of claim 1, wherein the rolling mechanism is temporarily detachable and removable.

14. The transportable workstation of claim 13, wherein a snap-fit mechanism allows the roller mechanism to be removed from the bottom portion and secured to the bottom portion by applying a threshold amount of force.

15. The transportable workstation of claim 1, wherein the body of the transportable workstation includes one or more secondary handles integrated with an outer external surface of one or more sidewalls of the body.

16. The transportable workstation of claim 1, wherein the body of the transportable workstation includes one or more storage receptacles.

17. The transportable workstation of claim 1, further including an outer frame configured at one or more edges of the body, wherein the frame includes substantially rigid materials configured to withstand and absorb impact forces to prevent damage.

18. The transportable workstation of claim 17, wherein the frame extends beyond an exterior surface of the body to physically block structures from contacting the body.

19. The transportable workstation of claim 1, further including one or more ancillary components, including a paper towel holder.

20. The transportable workstation of claim 1, wherein the at least one work surface includes one or more extendable portions configured to slide between retracted positions and extended positions.
